(19) United States
(12) Patent Application Publication
(10) Pub. No.: US 2025/0016455 A1
(43) Pub. Date: Jan. 9, 2025

(54) 360° MANHOLE INSPECTION SYSTEM AND METHOD

(71) Applicant: ENVIROSIGHT LLC, Randolph, NJ (US)

(72) Inventors: Stéphane CUENET, Porrentruy (CH); Wolfram KOEGLER, Mittelberg (AT); Jacob WELLS, Portland, OR (US)

(21) Appl. No.: 18/647,910

(22) Filed: Apr. 26, 2024

Related U.S. Application Data
(63) Continuation of application No. PCT/US22/47877, filed on Oct. 26, 2022.
(60) Provisional application No. 63/272,083, filed on Oct. 26, 2021.

(51) Int. Cl. H04N 23/698; G01N 21/954; G03B 17/56; H04N 23/56; H04N 23/66; H04N 23/68

(52) U.S. Cl. CPC H04N 23/698; G03B 17/561; H04N 23/56; H04N 23/66; H04N 23/6812; G01N 21/954; G01N 2201/102

(57) ABSTRACT

A system for automatically obtaining 360° manhole video data, said system comprising a housing; a 360° video camera in said housing, one or more lights disposed in said housing, a digital processor disposed in said housing, a distance finder disposed in said housing, and digital storage disposed in said housing for storing digital data from said 360° video camera, wherein said digital processor is configured to automatically obtain manhole video data by commencing acquisition of video data once said housing is maintained at the same vertical position from the bottom of the manhole, as determined by said distance finder, for a predetermined time, once said digital processor commences acquiring video data, prompting a user to begin lowering said housing; stopping acquisition of said video data once said housing is a predetermined distance from said bottom of the manhole, and prompting said user to withdraw the housing from said manhole.

### REFERENCE TO RELATED APPLICATION

This application is based on U.S. Provisional Application No. 63/272,083, filed Oct. 26, 2021, which is incorporated herein by reference in its entirety, including its appendices.

### FIELD OF INVENTION

The present invention relates generally to apparatuses and methods for the inspection of access structures, vertical shafts, tunnels, and other conduits, and more specifically, to apparatuses and methods for the inspection of manholes to catalog their locations and general conditions including size, shape, appearance, structural condition (e.g., manhole ring, walls, and inverts), and location of lateral connections.

### BACKGROUND

Manholes provide access to sewer systems at the surface and extend down to sewer pipes. Manholes and other access structures are essential to the ongoing inspection, maintenance, and renovation of sewer systems. Inspection of manholes provides valuable information for maintenance and repair of sewer systems. Prior art methods of manhole inspection, however, do not provide comprehensive, repeatable, and measurable inspections.

Applicant has identified the need for a simple manhole inspection device, which is automated and leaves the guesswork out of performing inspections. The present invention fulfills this need among others.

### SUMMARY OF INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

A method for automatically obtaining 360° manhole video data, said method comprising: (a) commencing acquisition of video data once said system is maintained at a constant vertical position from the bottom of the manhole for a predetermined time; (b) once said system commences acquiring video data, prompting a user to begin lowering said system into said manhole; (c) stopping acquisition of said video data once the system is a predetermined distance from said bottom of said manhole; and (d) prompting said user to withdrawal said system from said manhole.

A method for obtaining 360° manhole video data, said method comprising: (a) maintaining a 360° manhole video data system in a manhole at a constant vertical position from the bottom of the manhole for a predetermined time to commence acquisition of video data; (b) lowering said system into said manhole after receiving a prompt from said system to lower said system once said system commences acquisition of video data; and (c) withdrawing said system from said manhole after receiving a prompt from said system once it reaches a predetermined distance from said bottom of the manhole.

A system for automatically obtaining 360° manhole video data, said system comprising: (a) a housing; (b) a power supply in said housing; (c) a 360° video camera in said housing and operatively connected to said power supply; (d) one or more lights disposed in said housing and operatively connected to said power supply; (e) a digital processor disposed in said housing and operatively connected to said power supply and said camera; (f) a distance finder disposed in said housing and operatively connected to at least said power supply and said digital processor; and (g) digital storage disposed in said housing and operatively connected to at least said power supply and said digital processor for storing digital data from said 360° video camera; wherein said digital processor is configured to automatically obtain manhole video data by (i) commencing acquisition of video data once said housing is maintained at the same vertical position from the bottom of the manhole, as determined by said distance finder, for a predetermined time; (ii) once said digital processor commences acquiring video data, prompting a user to begin lowering said housing; (iii) stopping acquisition of said video data once the housing is a predetermined distance from said bottom of the manhole; and (iv) prompting said user to withdraw the housing from said manhole.

A system for obtaining a 360° video of a manhole, said system comprising: (a) a housing having at least a planar portion defining first and second opposing sides and one or more edges essentially orthogonal to said first and second opposing sides; (b) a 360° video camera in said planar portion, said camera comprising first and second lenses, said first lens protruding from said first opposing side and said second lens protruding from said second opposing side; (c) one or more lights disposed along said at least one edge and operatively connected to said power supply; (d) a digital processor disposed in said; (e) a distance finder disposed in said housing; and (f) a digital storage disposed in said housing for storing digital data from said 360° video camera.

### BRIEF DESCRIPTION OF FIGURES

FIG. 1 is a perspective view of one embodiment of the camera module of the present invention.

FIG. 2 is a side view of the embodiment of FIG. 1.

FIG. 3 is a schematic block diagram of one embodiment of the inspection system of the present invention.

FIG. 4 is a perspective view of one embodiment of the upper housing of the camera module of the present invention.

FIG. 5 is a top view of one embodiment of the planar portion of the camera module of the present invention.

FIG. 6 is a schematic view of the camera module being lowered in a manhole.

### DETAILED DESCRIPTION

Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

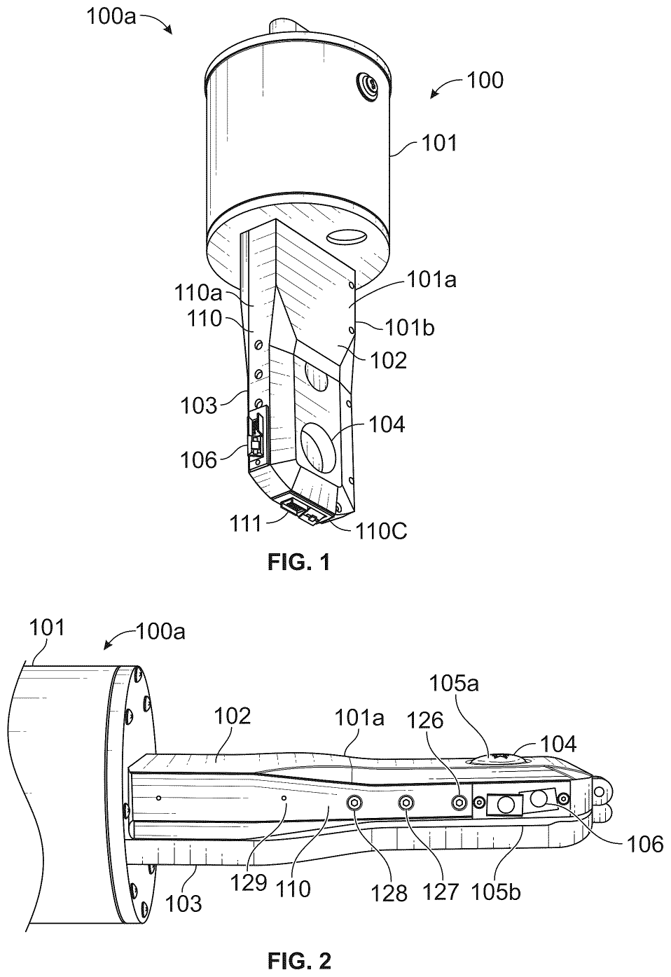

Referring to FIGS. 1-2, one embodiment of a system 100 of the present invention is shown. The system 100 is configured for obtaining a 360° video of a manhole, and comprises a camera device 100a, having a housing 101. In this particular embodiment, the housing 101 comprises a planar portion 101a and an upper housing 101b. The planar portion comprises first and second opposing sides 102,103, and one or more edges 110 essentially orthogonal to the first and second opposing sides. The upper portion 101b, in this embodiment, is configured for attachment to a pole (not shown). A 360° video camera 104 is disposed in the planar portion and comprises first and second lenses 105a, 105b, the first lens protruding from the first opposing side and the second lens protruding from the second opposing side. One or more lights 106 is disposed along the edge. A distance finder 111 is disposed in the housing 101 and is configured for measuring the distance from the housing 101 to the bottom of the manhole. A digital processor (not shown) and digital storage (not shown) are also disposed in the housing 101 and are configured to operate the camera, light(s), and distance finder to obtain 360° video of the manhole.

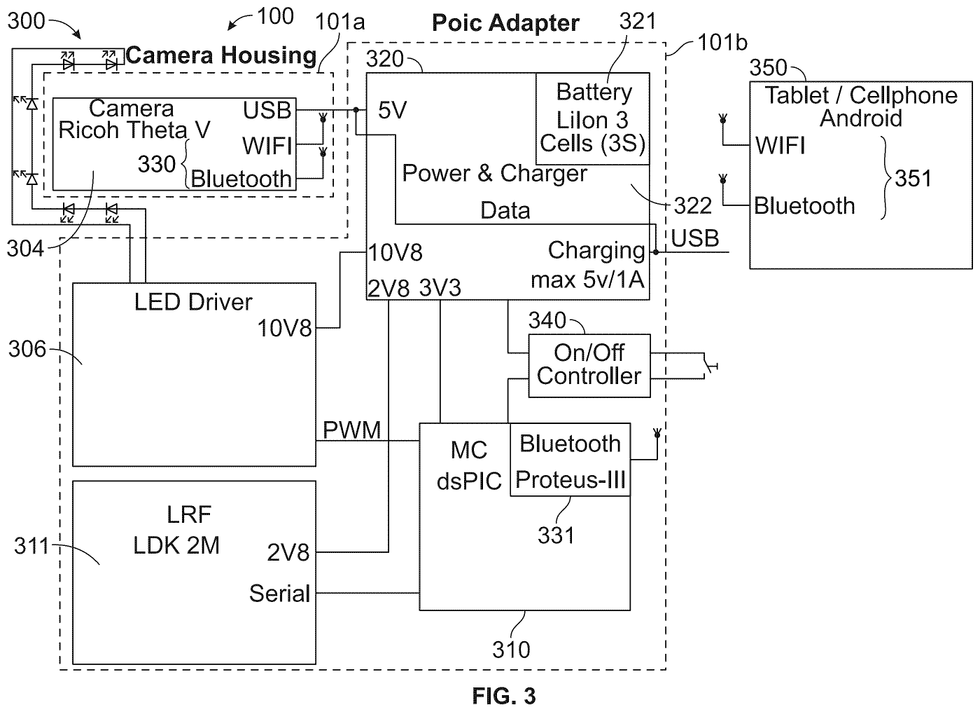

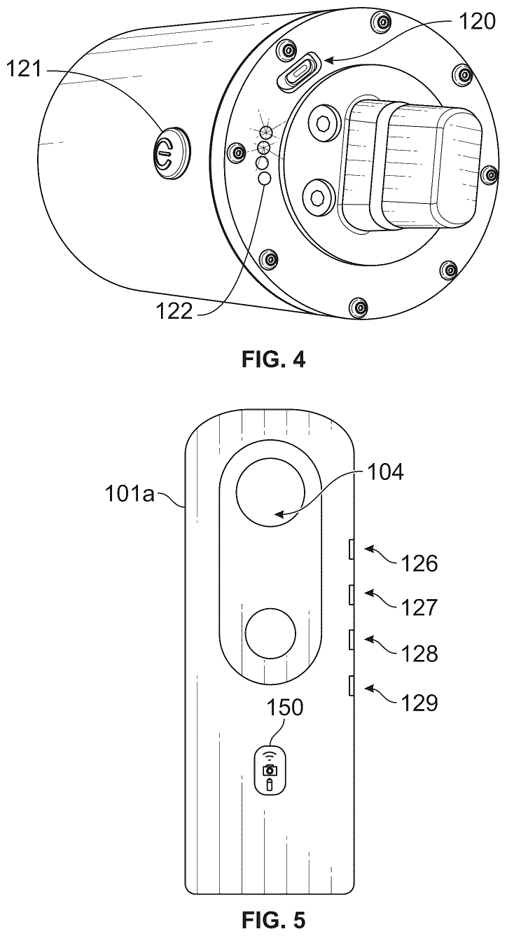

Referring to FIG. 3, a block diagram 300 of one embodiment of the system 100 is shown. In this embodiment, a camera module 304 having a wireless interface 330 is housed in the camera housing or planar portion 101a described above. In this embodiment, the LED driver 306 for lights 106 is housed in the upper housing 101b described above. Also contained in the upper housing 101b is the distance finder module 311, a digital processor 310 having a wireless interface 331, and a power module 320 comprising power/charging control 322, as well as a battery 321. In this embodiment, there is also an on-off controller 340 for turning the processor on/off. This switch 121 is conveniently located on the exterior of the housing 101 as shown in FIG. 4. This embodiment of the system 100 also includes remote operator control 350 wirelessly connected to the processor and/or camera via wireless interface 351.

These features are described below in greater detail along with selected alternative embodiments.

### Remote User Interface

In one embodiment, the system 100 comprises a remote user interface 100b such as a smart phone or tablet or other computer device to interface with the camera module 100a. In one embodiment, the remote user interface is linked wirelessly (e.g., Wi-Fi or Bluetooth) to the camera module 100a using any known pairing protocol/approach. By linking a remote user interface 100b to the camera module 100b, the user is able to control the operation of the system (e.g., power on/off, lights on/off, mode video/photo), and monitor other parameters such battery level. In one embodiment, the remote user interface also provides the user with instructions to operate the system 100. For example, the remote user interface may display instructions to (1) start lowering the camera module, (2) lower the camera module slower, and/or (3) withdraw the camera module because the inspection completed. In addition to controlling the operation of the system 100, the remote user interface can also be used to manage the data received from the system 100, including organizing the data into projects and editing the data. In one embodiment, the remote user interface is facilitated using the commercially-available WinCan application.

### Camera

The camera functions to provide both video and still images of the manhole. Such cameras are well known and commercially available (e.g., the THETA SC2 from Ricoh), and thus, will not be discussed in detail herein. In one embodiment, as shown in FIG. 5, the camera comprises an external on-off switch 126 for powering the camera. In a more particular embodiment, the camera also comprises a Wi-Fi button 127 for initiating a Wi-Fi connection between the camera module and the remote user interface, a mode button 128 for selecting between video mode or photo mode, and a self-timer button 129. In one embodiment, the camera module has a status indicator 150 to indicate the status of the Wi-Fi connection, camera mode, and battery power.

### Processor/Operation

One embodiment of the present invention is a simple manhole inspection device, which is essentially automated, thereby eliminating guesswork from manhole inspections. Specifically, in one embodiment, the system 100 comprises a digital processor for initiating the acquisition of data, communicating to the user while acquiring the data to provide real time feedback to ensure proper acquisition of the inspection data, automatically stopping the inspection and communicates with the user that the inspection is completed, and, finally, transferring the inspection data as configured by the user. The processor may be any known digital processor for executing instructions from a configured memory/digital storage.

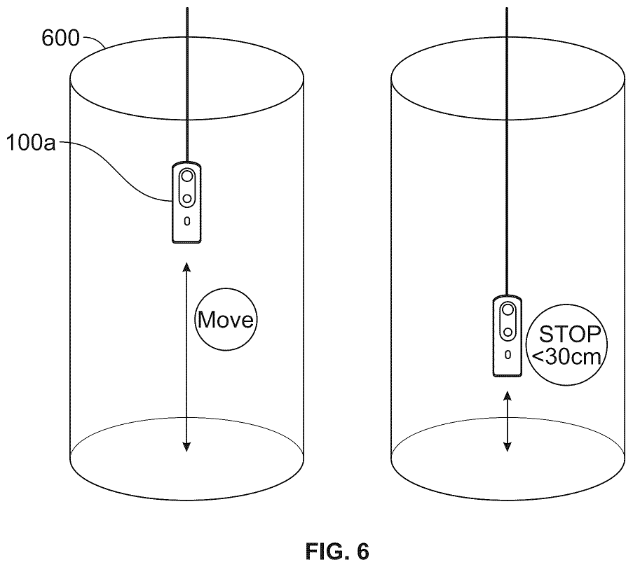

In one embodiment, the digital processor is configured to commence acquisition of video data once the housing is maintained at the same vertical position from the bottom of the manhole for a predetermined time—e.g., about 3-10 seconds. In other words, referring to FIG. 6, once the user holds the camera module 100a in place at the top of the manhole 600 for a predetermined time, the system commences data acquisition, which, in one embodiment, involves storing output of the camera in a data store. The vertical position of the module 100a is determined using the distance finder (described below).

In one embodiment, once the digital processor commences acquiring data, the digital processor is configured to prompt a user to begin lowering the housing. There are different ways in which the system can prompt the user to begin lowering the housing. For example, in one embodiment, the digital processor prompts the user by causing the light(s) 106 to turn on. Alternatively, an audio signal may be provided, or the user may be prompted via the smart phone or tablet. Still other means of prompting the user will be obvious to those in light of this disclosure.

In one embodiment, the digital processor is configured to evaluate distance data received from the distance finder to determine the rate of descent of the module in the manhole, and, if the rate of descent is too fast, the digital processor is configured to cause a message to be transmitted to a user to slow the rate of descent. In one embodiment, the digital processor is also configured to cause a message to be transmitted to a user to increase the speed of descent if the rate of descent is too slow. There are various approaches to convey this information to the user. In one embodiment, the information is communicated to the user via the remote user control through an audio and/or visual signal. Alternatively, the camera module itself may be used to communicate this information. For example, in one embodiment, the lights may flash quickly or change color to indicate that the user is lowering the device to quickly/slowly. Still other approaches for messaging the user will be obvious to those of skill the art in light of this disclosure.

In one embodiment, the digital processor is configured to stop acquiring video data once the housing is a predetermined distance from the bottom of the manhole—e.g., 0.2 m-0.5 m. In one embodiment, the system 100 prompts the user that the inspection is complete. Again, this can be done in different ways. In one embodiment, this information is communicated to the user through the remote user interface via an audio and/or visual signal. In another embodiment, the information is indicated by the camera module itself. For example, in one embodiment, the digital processor is configured to turn off the lights when the acquisition of video data has stopped.

In one embodiment, the digital processor is configured to automatically wirelessly transmit the inspection data once the acquisition of video data has stopped. In one embodiment, this wireless transmission commences once the camera device is withdrawn from the manhole sufficiently to wirelessly connect to the remote user interface. In one embodiment, the data is transmitted to the remote user interface. Alternatively, the data may be transmitted to the cloud or Internet storage facility. Again, other data store locations will be obvious to those of skill the art in light of this disclosure. Although a wireless transmission of data is disclosed herein, those of skill he art in light of this disclosure will appreciate other approaches. For example, rather than wirelessly transmitting the data, the data may be transmitted via a cable that is either permanently or temporarily connected to the camera module.

### Power Supply

The power supply functions to provide power to the camera module, the processor, and the distance finder. In one embodiment, as shown in FIG. 3, the power module comprises power supply/charger circuitry 320 and a battery 321. Such circuitry is known and will not be discussed in detail herein. In one embodiment, charging of the battery is facilitated through port 121 as shown in FIG. 4, which is configured to attach to a known charging cable. For example, port 121 may be configured to attach to a USB cable. In one embodiment, the power level of the battery is indicated in a batter status indicator 122 on the housing 101.

Although system 100 is depicted herein as having a battery supply, it should be understood that other embodiments are possible. For example, rather than a battery supply, the camera module 100a may be powered by a cable, in which case, the battery and the power supply/charger circuitry would not be needed. In this embodiment, the cable may be used not only to power the camera module, but also supported it as it is lowered into the manhole. Again, those of skill the art will understand obvious modifications to this disclosure in light of this disclosure.

### Lights

The light(s) 106 of the system 100 function to provide sufficient lighting to image the interior of the manhole. In one embodiment, the system 100 provides lighting along the edge of the planar portion 101a. In one embodiment, multiple lights are disposed along the at least one edge. For example, in one embodiment, the planar portion 101a comprises two side edges 110a, 110b in a bottom edge 110c, and at least one light is disposed on each of the side edges and the bottom edge. By having the light project not only downward but radially from the camera, Applicant discovered unexpectedly that the quality of the video and photo images increased significantly. In one embodiment, the lights are LED lights. In such an embodiment, an LED driver is disposed in either the upper housing 101b, or the camera housing 101a.

### Distance Finder

An important aspect of one embodiment of the present invention is monitoring the distance of the camera module 100a from the bottom of the manhole. Specifically, as described above, this measurement may be used to both start and stop the inspection process. The distance finder is also used to obtain distance data for registering the video to a vertical position within the manhole. Therefore, having a device that accurately measures the distance of the camera module from the bottom of the manhole is important at least with respect to this embodiment of the invention. In one embodiment, the distance finder is disposed along the bottom edge such that the distance finder is directed to the bottom of the manhole when the system is positioned in a manhole. In one embodiment, the distance finder is a laser distance finder, although it should be understood that other distance finders are possible. For example, in one embodiment, rather than a laser, a sonar distance finder may be used. In yet another embodiment, physical feelers are used to measure the distance between the camera module and the bottom of the manhole. Those of skill in the art will appreciate other means of determining the distance between the camera module and the bottom of the manhole in light of this disclosure.

### Housing

The housing functions to provide a water resilient/waterproof enclosure for the above described components. Additionally, in one embodiment, the housing provides for attachment to an elongated member/pole. Accordingly, in one embodiment, the housing 101 comprises a planar portion 101a for housing the camera module 304, and a pole adapter portion or upper portion 101b for housing the other components including the power supply/charger module 320, the LED driver 306, the distance finder module 311, and the processor 330 and associated memory/data storage.

In one embodiment, the upper portion 101b is configured for attachment to an elongated member such as that disclosed in U.S. Pat. No. 8,054,459B2. Although these configurations may vary, in one embodiment, the upper portion 101b is round to be received in a socket of pole or elongated member. In one embodiment, the system 101 also comprises a stand for supporting the elongated member approximately in the center of the manhole. The stand is configured to enable a user to lower the housing into the manhole. Such stands are well-known and typically resemble a tripod, although other configurations will be obvious to those of skill the art in light of this disclosure.

Although a rigid elongated member is disclosed herein, those of skill in the art in light of this disclosure will appreciate alternatives. For example, rather than a rigid pole, the camera module may be attached to a cable suitable for lowering/raising the camera module in the manhole. In such an embodiment, the cable may be suitable for providing power and/or transmitting inspection data from the camera module to a data store.

Having thus described a few particular embodiments of the invention, various alterations, modifications, and improvements will readily occur to those skilled in the art. Such alterations, modifications, and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A system for automatically obtaining 360° manhole video data, said system comprising:
a housing;
a 360° video camera in said housing;
one or more lights disposed in said housing;
a digital processor disposed in said housing;
a distance finder disposed in said housing; and
digital storage disposed in said housing for storing digital data from said 360° video camera;
wherein said digital processor is configured to automatically obtain manhole video data by
commencing acquisition of video data once said housing is maintained at the same vertical position from the bottom of the manhole, as determined by said distance finder, for a predetermined time;
once said digital processor commences acquiring video data, prompting a user to begin lowering said housing;
stopping acquisition of said video data once said housing is a predetermined distance from said bottom of the manhole; and
prompting said user to withdraw the housing from said manhole.

2. The system of claim 1, wherein said predetermined time is about 3-10 seconds.

3. The system of claim 1, wherein commencing acquisition of said video data comprises said digital processor causing said at least one light to turn on.

4. The system of claim 1, wherein said digital processor is configured to evaluate distance data received from said distance finder to determine the rate of descent of said module in said manhole, and, if the rate of descent is too fast, said digital processor is configured to cause a message to be transmitted to a user to slow the rate of descent.

5. The system of claim 1, wherein said predetermined distance is 0.2 m-0.5 m.

6. The system of claim 1, wherein said digital processor is configured to turn off said lights when the acquisition of video data is stopped.

7. The system of claim 1, further comprising:
wherein said digital processor is configured to automatically wirelessly transmit said video data once the acquisition of video data has stopped.

8. The system of claim 1, wherein multiple lights are disposed along said at least one edge.

9. The system of claim 1, wherein said distance finder is a laser distance finder.

10. The system of claim 1, wherein said at least one edge comprises two side edges in a bottom edge.

11. The system of claim 10, wherein said distance finder is disposed along said bottom edge such that said distance finder is directed to the bottom of the manhole when the system is positioned in a manhole.

12. The system of claim 10, wherein at least one light is disposed on each of said side edges and said bottom edge.

13. The system of claim 1, further comprising:
a power supply comprising a battery; and
a port on said housing for charging said power supply.

14. The system of claim 13, wherein said port is a USB charging cable or a wall outlet charging adapter.

15. The system of claim 1, wherein said housing further comprises an interface for connecting to an elongated member to facilitate extension down into a manhole

16. The system of claim 15, further comprising:
an elongated member connect to said interface.

17. The system of claim 16, further comprising:
a stand for supporting said elongated member approximately in the center of the manhole, said stand being configured to enable a user to lower said housing.

18. The system of claim 1, further comprising:
an external on-off switch for powering the digital processor.

19. The system of claim 1, further comprising:
an external on-off switch for powering said camera.

20. A method for obtaining 360° manhole video data, said method comprising:
maintaining a 360° manhole video data system in a manhole at a constant vertical position from the bottom of the manhole for a predetermined time to commence acquisition of video data
lowering said system into said manhole after receiving a prompt from said system to lower said system once said system commences acquisition of video data; and
withdrawing said system from said manhole after receiving a prompt from said system once it reaches a predetermined distance from said bottom of the manhole.

21. A method for automatically obtaining 360° manhole video data, said method comprising:
commencing acquisition of video data once said system is maintained at a constant vertical position from the bottom of the manhole for a predetermined time;
once said system commences acquiring video data, prompting a user to begin lowering said system into said manhole;
stopping acquisition of said video data once the system is a predetermined distance from said bottom of said manhole; and
prompting said user to withdrawal said system from said manhole.

22. The method of claim 21, wherein prompting a user to begin lowering the device comprises turning on lights of said system.

23. The method of claim 21, wherein prompting said user to withdraw said system comprises turning off said lights of said system.

24. The method of claim 21, further comprising wirelessly transmitting said video data from said system to a user device once the system is withdrawn from the manhole sufficiently to wirelessly connect to said user device.

25. A system for obtaining a 360° video of a manhole, said system comprising:
a housing having at least a planar portion defining first and second opposing sides and one or more edges essentially orthogonal to said first and second opposing sides;
a 360° video camera in said planar portion and operatively connected to said power supply, said camera comprising first and second lenses, said first lens protruding from said first opposing side and said second lens protruding from said second opposing side;
one or more lights disposed along said at least one edge;
a digital processor disposed in said housing;
a distance finder disposed in said housing and operatively connected to at least said digital processor; and
digital storage disposed in said housing and operatively connected to at least said digital processor for storing digital data from said 360° video camera.

26. The system of claim 25, wherein said digital processor is configured to automatically obtain manhole video data.

27. The system of claim 26, wherein said digital processor is configured to commence acquisition of video data once said housing is maintained at the same vertical position from the bottom of the manhole, as determined by said distance finder, for a predetermined time.

28. The system of claim 27, wherein said predetermined time is about 3-10 seconds.

29. The system of claim 27, wherein, once said digital processor commences acquiring video data, said digital processor is configured to prompt a user to begin lowering said housing.

30. The system of claim 27, wherein, once said digital processor commences acquiring video data, said digital processor is configured to cause said lights to turn on.

31. The system of claim 26, wherein said digital processor is configured to evaluate distance data received from said distance finder to determine the rate of descent of said module in said manhole, and, if the rate of descent is too fast, said digital processor is configured to cause a message to be transmitted to a user to slow descent.

32. The system of claim 26, wherein said digital processor is configured to stop acquiring video data once the housing is a predetermined distance from said bottom of the manhole.

33. The system of claim 32, wherein said predetermined distance is 0.2 m-0.5 m.

34. The system of claim 32, wherein said digital processor is configured to turn off said lights when the acquisition of video data is stopped.

35. The system of claim 26, wherein said digital processor is configured to automatically transmit said inspection data once the acquisition of video data is stopped.

36. The system of claim 25, wherein multiple lights are disposed along said at least one edge.

37. The system of claim 25, wherein said distance finder is a laser distance finder.

38. The system of claim 25, wherein said at least one edge comprises two side edges in a bottom edge.

39. The system of claim 38, wherein said distance finder is disposed along said bottom edge such that said distance finder is directed to the bottom of the manhole when the system is positioned in a manhole.

40. The system of claim 38, wherein at least one light is disposed on each of said side edges and said bottom edge.

41. The system of claim 25, further comprising a power supply in said housing.

42. The system of claim 41, further comprising:
a port on said housing for charging said power supply.

43. The system of claim 42, wherein said port is a USB charging cable or a wall outlet charging adapter.

44. The system of claim 25, wherein said housing further comprises an interface for connecting to an elongated member to facilitate extension down into a manhole

45. The system of claim 44, further comprising:
an elongated member connect to said interface.

46. The system of claim 45, further comprising:
a stand for supporting said elongated member approximately in the center of the manhole, said stand being configured to enable a user to lower said housing.

47. The system of claim 25, further comprising:
an external on-off switch for powering the digital processor.

48. The system of claim 25, further comprising:
an external on-off switch for powering said camera.

49. The system of claim 25, further comprising:
a remote user interface linked to said processor.

50. The system of claim 49, wherein said remote user interface is a smartphone.
